(19) United States
(12) Patent Application Publication
(10) Pub. No.: US 2023/0367096 A1
(43) Pub. Date: Nov. 16, 2023

(54) IMAGING-LENS MANUFACTURING APPARATUS

(71) Applicant: Sharp Sensing Technology Corporation, Tenri City (JP)

(72) Inventor: Akihiro IIDA, Tenri City (JP)

(21) Appl. No.: 18/139,412

(22) Filed: Apr. 26, 2023

(30) Foreign Application Priority Data
May 16, 2022 (JP) 2022-080301

(51) Int. Cl. G02B 7/02

(52) U.S. Cl. CPC G02B 7/023; G02B 7/021; H04N 23/55

(57) ABSTRACT

An imaging-lens manufacturing apparatus includes the following: a lens stage configured to hold at least a fixed lens; a lens adjusting mechanism configured to hold an adjusted lens, and capable of adjusting, in a plane perpendicular to the optical axis of an imaging lens, the position of the adjusted lens with respect to the fixed lens; a light source; a reticle having three or more slits that allow light from the light source to pass; and a light detecting unit having a plurality of sensors each configured to detect, via the imaging lens, a corresponding one of a plurality of light-ray bundles passed through the slits. The lens adjusting mechanism is further capable of driving the adjusted lens in the direction of the optical axis.

### BACKGROUND

### Field

The disclosure relates to an imaging-lens manufacturing apparatus that adjusts a lens on the basis of information about an image captured by an image pickup element.

### Description of the Related Art

Recent rapid advancement toward high resolution and high performance in camera modules makes it difficult to improve component accuracy in conformance with the advancement to high resolution. Highly accurate assembly is required because the accuracy of assembly of a plurality of lenses that constitute an imaging lens in the process of manufacturing the imaging lens considerably affects the ratio of non-defective products in the process of manufacturing the imaging lens.

By the way, a known method in the process of manufacturing an imaging lens is adjusting the optical performance of the imaging lens by adjusting the position of an adjusted lens among a plurality of lenses disposed in the lens barrel’s body.

For instance, Japanese Unexamined Patent Application Publication No. 2010-230745 proposes a method of adjusting the tilt of an image plane by moving an adjusted lens horizontally on the basis of information about an image captured by an image pickup element, in such a manner that the absolute value of the tilt of a tangential image plane (hereinafter, a T-plane) with respect to the optical axis and the absolute value of the tilt of a sagittal image plane (hereinafter, an S-plane) with respect to the optical axis are substantially equal.

Further, Japanese Unexamined Patent Application Publication No. 2014-2422 proposes a structure that facilitates adjustment of an imaging lens. Japanese Unexamined Patent Application Publication No. 2014-2422 describes a method of adjustment that includes bringing the adjusted lens into contact with a fixed lens, then moving the adjusted lens in a biaxial direction perpendicular to the optical axis while holding the adjusted lens with a jig, and positioning the adjusted lens in a location where the imaging lens exerts its optical performance at maximum.

### SUMMARY

However, Japanese Unexamined Patent Application Publication No. 2010-230745 is silent about how to adjust the adjusted lens. Furthermore, the T-plane and the S-plane have their tilts remaining after adjustment in the invention described in Japanese Unexamined Patent Application Publication No. 2010-230745. Japanese Unexamined Patent Application Publication No. 2010-230745 thus requires the imaging lens or an image sensor of a camera module to undergo tilt adjustment in order to use the imaging lens after adjustment effectively.

Further, the invention described in Japanese Unexamined Patent Application Publication No. 2014-2422, which includes bringing the adjusted lens and the fixed lens into contact in the adjustment of the imaging lens, involves frictional resistance between these lenses. This frictional resistance can produce a backlash in the fine-movement stage, which is used for the adjustment of the imaging lens, or can produce an internal stress within the imaging lens, thereby causing a deterioration in adjustment accuracy.

In view of the above problem, one aspect of the disclosure aims to provide an imaging-lens manufacturing apparatus that can manufacture a high-accuracy imaging lens.

To solve the above problem, an imaging-lens manufacturing apparatus according to one aspect of the disclosure manufactures an imaging lens provided with a plurality of lenses including an adjusted lens that is used in assembly. The imaging-lens manufacturing apparatus includes the following: a lens stage configured to hold at least the plurality of lenses excluding the adjusted lens; a lens adjusting mechanism configured to hold the adjusted lens, and capable of adjusting, in a plane perpendicular to the optical axis of the imaging lens, the position of the adjusted lens with respect to the plurality of lenses excluding the adjusted lens; a light source; a reticle disposed between the imaging lens and the light source, and having three or more slits that allow light from the light source to pass; and a light detecting unit having a plurality of sensors each configured to detect, via the imaging lens, a corresponding one of a plurality of light-ray bundles composed of the light from the light source passed through the three or more slits. The lens adjustment mechanism is further capable of driving the adjusted lens in the direction of the optical axis.

### Effect of the Invention

The aspect of the disclosure can provide an imaging-lens manufacturing apparatus that can manufacture a high-accuracy imaging lens.

### BRIEF DESCRIPTION OF THE DRAWINGS

FIG. 1 is a schematic diagram of an example configuration of an imaging-lens manufacturing apparatus according to a first preferred embodiment of the disclosure;

FIG. 2 illustrates, by way of example, how a lens adjusting mechanism of the imaging-lens manufacturing apparatus adjusts an adjusted lens;

FIG. 3 is a top view of an example reticle of the imaging-lens manufacturing apparatus;

FIG. 4 is a schematic diagram of example pathways of light-ray bundles in the imaging-lens manufacturing apparatus;

FIG. 5 schematically illustrates the relationship between PS and a focal-point position;

FIG. 6 is a schematic diagram showing, in each light-ray bundle, the relationship between a position in the direction of the optical axis and optical performance; and

FIG. 7 is a flowchart showing, by way of example, how the imaging-lens manufacturing apparatus manufactures an imaging lens.

### DESCRIPTION OF THE EMBODIMENTS

### Preferred Embodiment

A preferred embodiment of the disclosure will be detailed. The following describes, by way of example, an imaging-lens manufacturing apparatus according to the disclosure, and the technical scope of the disclosure is thus not limited to the illustrated examples. It is noted that some of the drawings describe, as appropriate, a coordinate system with its X- Y- and Z-axes orthogonal to each other. In the coordinate system, the direction of an optical axis L of an imaging lens 110 placed in an imaging-lens manufacturing apparatus 100 will be referred to as a Z-axis direction. Further, the width direction of the imaging-lens manufacturing apparatus 100 orthogonal to the Z-axis direction will be referred to as an X-axis direction, and the depth direction of the imaging-lens manufacturing apparatus 100 orthogonal to the X-axis direction and the Z-axis direction will be referred to as a Y-axis direction.

### Imaging-Lens Manufacturing Apparatus

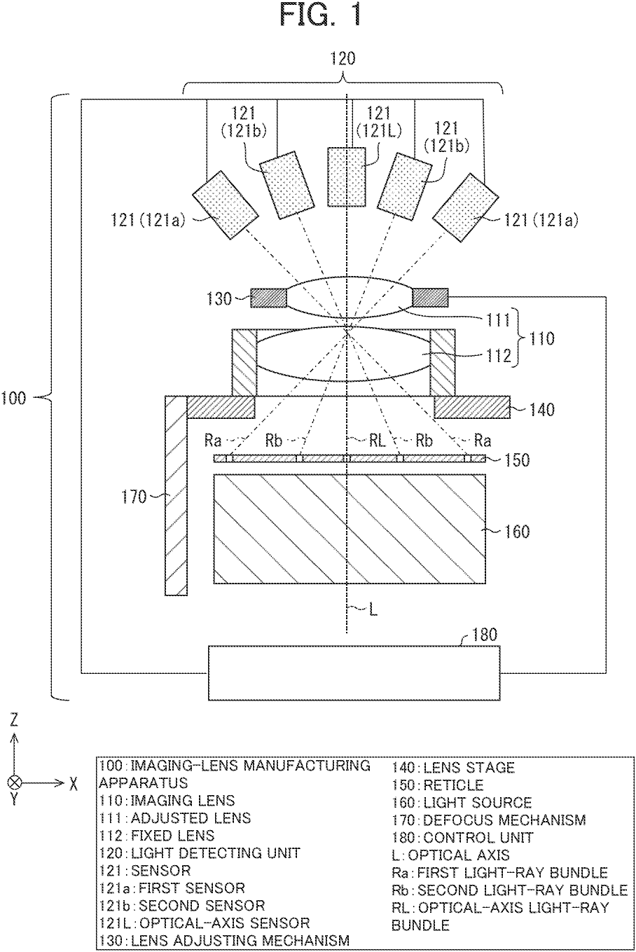

FIG. 1 is a schematic diagram of an example configuration of the imaging-lens manufacturing apparatus 100 according to the first preferred embodiment of the disclosure. The imaging-lens manufacturing apparatus 100 is an apparatus that manufactures the imaging lens 110 provided with a plurality of lenses including an adjusted lens 111 that is used in assembly.

The imaging lens 110 is composed of the adjusted lens 111 and a fixed lens 112. A plurality of adjusted lenses 111 and a plurality of fixed lenses 112 may be provided.

The imaging-lens manufacturing apparatus 100 includes a light detecting unit 120, a lens adjusting mechanism 130, a lens stage 140, a reticle 150, a light source 160, a defocus mechanism 170, and a control unit 180.

The lens stage 140 holds at least lenses (fixed lens 112) excluding the adjusted lens 111. The lens stage 140 is held by the defocus mechanism 170 that drives in the direction of the optical axis L of the imaging lens 110.

The defocus mechanism 170 performs defocus in which the distance of the reticle 150 with respect to the lenses (fixed lens 112) excluding the adjusted lens 111 held by the lens stage 140 undergoes change in the direction of the optical axis L. The defocus mechanism 170 moves the lens stage 140 in the direction of the optical axis L to perform defocus.

The light source 160 emits light toward the imaging lens 110.

### Lens Adjusting Mechanism

The lens adjusting mechanism 130 holds the adjusted lens 111 and can adjust, in a plane perpendicular to the optical axis L of the imaging lens 110 (a plane passing through the X-axis and the Y-axis), the position of the adjusted lens 111 with respect to the fixed lens 112.

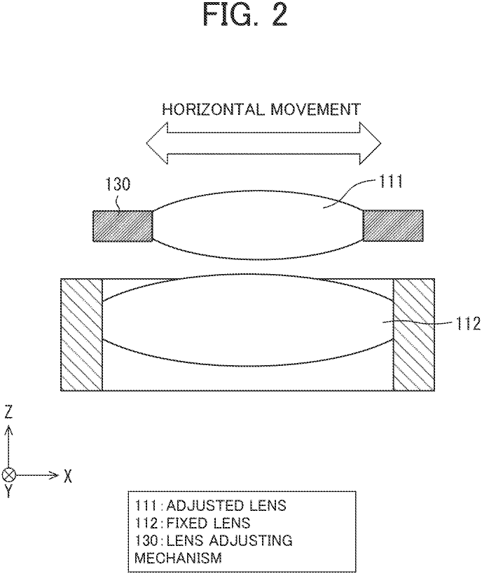

FIG. 2 illustrates, by way of example, how the lens adjusting mechanism 130 of the imaging-lens manufacturing apparatus 100 adjusts the adjusted lens 111. The adjusted lens 111 undergoes positional adjustment in the plane perpendicular to the optical axis L, as illustrated in FIG. 2 (open arrow in FIG. 2).

The lens adjusting mechanism 130 includes a biaxial fine-movement stage that can adjust the adjusted lens 111 in the plane perpendicular to the optical axis L while holding the adjusted lens 111. The lens adjusting mechanism 130 with this configuration moves the adjusted lens 111 in the plane perpendicular to the optical axis L to adjust the imaging lens 110.

The lens adjusting mechanism 130 also includes a fine-movement stage that can drive in the direction of the optical axis L and can drive the adjusted lens 111 in the direction of the optical axis L. This can not only adjust the distance between the adjusted lens 111 and the fixed lens 112 suitably, but also separate the adjusted lens 111 from the fixed lens 112 when the adjusted lens 111 undergoes adjustment in the plane perpendicular to the optical axis L. As a result, a frictional resistance between the adjusted lens 111 and the fixed lens 112 in the adjustment of the imaging lens 110 can be reduced.

A frictional resistance, if generated between the adjusted lens 111 and the fixed lens 112, can produce a backlash in the fine-movement stage, which is used for the adjustment of the adjusted lens 111, or an internal stress within the imaging lens 110, thus causing deterioration in adjustment accuracy.

Atypical fine-movement stage involves a small backlash of about 5 µm, which can cause no problem in the imaging lens 110 of a large camera that is over 10 mm large in diameter, such as a single-lens reflex camera. However, a camera module for use in mobile equipment requires the imaging lens 110 to have considerably high specifications, and thus, the allowable adjustment accuracy of the imaging lens 110 needs to be 5 µm or smaller. This is because, but not limited to, that camera modules for use in mobile equipment have a fast-growing case where extremely tightly integrated image sensors are used for the purpose of size reduction, and that the imaging lens 110 having such a small F value as to take in much light is preferable to address hand-induce shakes.

A frictional resistance that occurs between the adjusted lens 111 and the fixed lens 112 in the adjustment of the imaging lens 110 is thus a serious problem in the manufacture of the imaging lens 110, which requires high accurate adjustment.

As earlier described, the lens adjusting mechanism 130, which includes a fine-movement stage capable of adjustment in the direction of the optical axis L, can separate the adjusted lens 111 from the fixed lens 112 before the imaging lens 110 undergoes adjustment in the plane perpendicular to the optical axis L.

To be specific, the adjusted lens 111 and the fixed lens 112 undergo separation by separating the adjusted lens 111 and the fixed lens 112 a little in the direction of the optical axis L from a state where a perimeter portion of the adjusted lens 111, which is closer to the perimeter than its effective diameter, or a frame component holding the adjusted lens 111 is in contact with a perimeter portion of the fixed lens 112, which is the closest to the adjusted lens 111 and closer to the perimeter than its effective diameter, or with a frame component holding the fixed lens 112. In other words, that the adjusted lens 111 and the fixed lens 112 are separated indicates a state where the perimeter portion of the adjusted lens 111, located closer to the perimeter than its effective diameter, is separated a little in the direction of the optical axis L from the perimeter portion of the fixed lens 12, located closer to the perimeter than its effective diameter, that is in contact with the perimeter portion of the adjusted lens 11.

At this time, the amount of their separation should not be set to such a degree that although depending on the optical design of the imaging lens 110, its optical properties degrade considerably. A frictional resistance needs to be prevented; hence, an about 10 µm separation is sufficient.

As a result, a frictional resistance can be reduced between the adjusted lens 111 and the fixed lens 112 in the adjustment of the imaging lens 110, thereby enabling a high-accuracy imaging lens to be manufactured. The adjusted lens 111 undergoes the foregoing positional adjustment, followed by movement in the direction of the optical axis L to a location where the adjusted lens 111 comes into contact with the fixed lens 112, and the adjusted lens 111 is finally fixed.

### Reticle

The reticle 150 is disposed between the imaging lens 110 and the light source 160 and has three or more slits 151 that allow light from the light source 160 to pass. The light from the light source 160 passes through the slits 151, thus obtaining a plurality of light-ray bundles.

The plurality of light-ray bundles include the following: an optical-axis light-ray bundle RL that coincides with the optical axis L; and a pair of first light-ray bundles Ra, a pair of second light-ray bundles Rb, a pair of third light-ray bundles (not shown), and a pair of fourth light-ray bundles (not shown), each of which is a pair of light-ray bundles that is emitted in a direction symmetric with respect to the optical axis L.

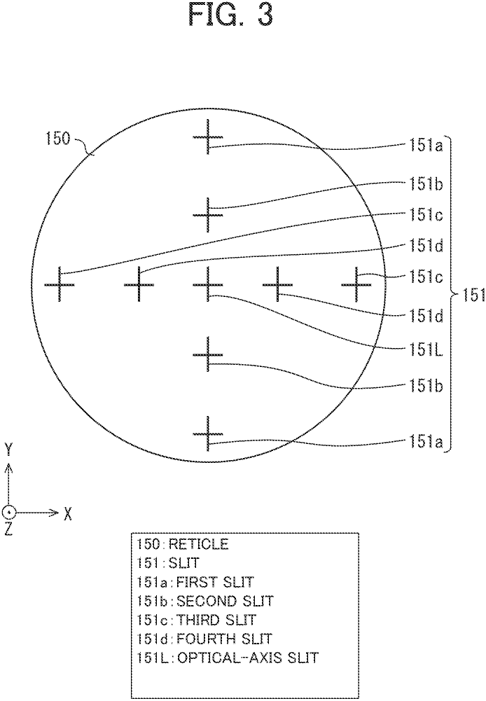

FIG. 3 is a top view of an example of the reticle 150 of the imaging-lens manufacturing apparatus 100. As illustrated in FIG. 3, the slits 151 include an optical-axis slit 151L, a pair of first slits 151a, a pair of second slits 151b, a pair of third slits 151c, and a pair of fourth slits 151d.

The light from the light source 160 passes through the optical-axis slit 151L, the pair of first slits 151a, the pair of second slits 151b, the pair of third slits 151c and the pair of fourth slits 151d, thus respectively obtaining the optical-axis light-ray bundle RL, the pair of first light-ray bundles Ra, the pair of second light-ray bundles Rb, the pair of third light-ray bundles and the pair of fourth light-ray bundles.

Each slit 151 is disposed in the reticle 150 in the following manner. The optical-axis slit 151L is disposed in such a manner that light-ray bundles that pass through the optical-axis slit 151L constitute the optical-axis light-ray bundle RL along the optical axis. That is, the optical-axis slit 151L is disposed on the optical axis.

The pair of first slits 151a is disposed in such a manner that each of the pair of first light-ray bundles Ra corresponds to an image height of 60% or greater (first adjustment image height) of the maximum image height. That is, the pair of first slits 151a is disposed in such a manner that each of the first light-ray bundles Ra concentrates, in an image plane, in a location having an image height of 60% or greater of the maximum image height. In other words furthermore, each of the first slits 151a is disposed in such a manner that an image is formed, in an image plane, in a location having an image height of 60% or greater of the maximum image height.

The pair of second slits 151b is disposed in such a manner that each of the pair of second light-ray bundles Rb corresponds to an image height of 10% or greater and 50% or smaller (second adjustment image height) of the maximum image height. That is, the pair of second slits 151b is disposed in such a manner that each of the second light-ray bundles Rb concentrates, in an image plane, in a location having an image height of 10% or greater and 50% or smaller of the maximum image height. In other words furthermore, each of the second slits 151b is disposed in such a manner that an image is formed, in an image plane, in a location having an image height of 10% or greater and 50% or smaller of the maximum image height.

The pair of third slits 151c is disposed in such a manner that each of the third light-ray bundles is emitted, from the first light-ray bundles Ra, in a direction rotated about the optical axis L. The pair of fourth slits 151d is disposed in such a manner that each of the fourth light-ray bundles is emitted, from the second light-ray bundles Rb, in the direction rotated about the optical axis L.

Here, an image height is a distance from the optical axis L in the plane perpendicular to the optical axis L; image heights on concentric circles with the optical axis L serving as their center are equal on the plane perpendicular to the optical axis L. Further, a maximum image height may coincide with the radius of an image circle in the plane perpendicular to the optical axis L. The radius of the image circle indicates a maximum radius at which an image can be formed.

Further, an image height that is used for the adjustment of the imaging lens 110 is defined as an adjustment image height. For an adjustment image height set at 50% of a maximum image height for instance, there are two locations having an adjustment image height of 50% of the maximum image height on a single axis passing through the optical axis L in the plane perpendicular to the optical axis L.

As illustrated in FIG. 3, the pair of first slits 151a is symmetric with respect to the optical-axis slit 151L for instance. Further, the pair of third slits 151c is symmetric with respect to the optical-axis slit 151L. The first slits 151a and the third slits 151c are disposed alternately at 90-degree pitches on an identical circle having the optical-axis slit 151L as its center.

The pair of second slits 151b is symmetric with respect to the optical-axis slit 151L. Further, the pair of fourth slits 151d is symmetric with respect to the optical-axis slit 151L. The second slits 151b and the fourth slits 151d are disposed alternately at 90-degree pitches on an identical circle having the optical-axis slit 151L as its center.

The second slits 151b are disposed on a straight line passing through the optical-axis slit 151L and the first slits 151a, and the fourth slits 151d are disposed on a straight line passing through the optical-axis slit 151L and the third slits 151c.

It is noted that the position of each slit 151 in the reticle 150 is not limited to the foregoing; each slit 151 needs to be disposed in the reticle 150 so as to be able to generate a light-ray bundle that corresponds to an image height (adjustment image height) that is used for the adjustment of the imaging lens 110. The imaging lens 110 undergoes adjustment on the basis of one or more adjustment image heights. The slits 151 may thus have only the optical-axis slit 151L and the first slits 151a for instance.

Further, the imaging lens 110 desirably undergoes adjustment on the basis of two or more adjustment image heights. The slits 151 in this case may have, for instance, only the optical-axis slit 151L, the first slits 151a and the second slits 151b or may have, for instance, the optical-axis slit 151L, the first slits 151a and the fourth slits151d. The reason why the imaging lens 110 desirably undergoes adjustment on the basis of two or more adjustment image heights will be detailed later on.

The reticle 150 is placed in a location coinciding approximately with the focal-point surface of the imaging lens 110 and is composed of a metal thin plate. Further, the slits 151 are desirably in the form of a cross along each direction in order to measure the optical performance in the tangential direction and sagittal direction at a predetermined image height.

The light emitted from the light source 160 passes through the slits 151, then enters and passes through the imaging lens 110 and is then detected by sensors 121, which constitutes the light detecting unit 120.

### Light Detecting Unit

The light detecting unit 120 has a plurality of sensors 121 each of which detects, via the imaging lens 110, a corresponding one of a plurality of light-ray bundles composed of the light from the light source 160 passed through the slits 151.

As illustrated in FIG. 1, the light detecting unit 120 has four or more sensors 121. The sensor 121 specifically includes an optical-axis sensor 121L, first sensors 121a, second sensors 121b, third sensors (not shown), and fourth sensors (not shown).

The optical-axis sensor 121L detects the optical-axis light-ray bundle RL. In other words, the optical-axis sensor 121L detects light at the center of the image circle. The optical-axis sensor 121L is disposed in a location coinciding substantially with the optical axis L.

The first sensors 121a through the fourth sensors detect light at a peripheral image height in the image circle. The peripheral image height is an image height in a location separated from the optical axis L by a predetermined distance.

The first sensors 121a detect the pair of respective first light-ray bundles Ra. The first sensors 121a in a pair are disposed symmetrically with respect to the optical axis L. The second sensors 121b detect the pair of respective second light-ray bundles Rb. The second sensors 121b in a pair are disposed symmetrically with respect to the optical axis L.

The third sensors detect the pair of respective third light-ray bundles. The third sensors are disposed symmetrically with respect to the optical axis L and are disposed in locations rotated about the optical axis L from the first sensors 121a. The fourth sensors detect the pair of respective fourth light-ray bundles. The fourth sensors are disposed symmetrically with respect to the optical axis L and are disposed in locations rotated about the optical axis L from the second sensors 121b.

It is noted that FIG. 1 illustrates a non-limiting instance where the sensors 121 are disposed so as to form a fan shape protruding in a direction where the light from the light source 160 is emitted. Arranging the sensors 121 in the form of a fan can prevent the size of the imaging-lens manufacturing apparatus 100. Further, placing the sensors 121 inside the dome portion of a dome-shaped support enables the sensors 121 to be arranged in the form of a fan. In this case, placing the sensors 121 in this support, which allows a placement angle for the sensors 121 to be determined roughly, facilitates the adjustment of the placement angle for the sensors 121.

The first sensors 121a, which detect the first light-ray bundles Ra, and the third sensors, which detect the third light-ray bundles, are disposed alternately at 90-degree pitches on an identical circle having the optical axis L as its center. Furthermore, the second sensors 121b, which detect the second light-ray bundles Rb, and the fourth sensors, which detect the fourth light-ray bundles, are disposed alternately at 90-degree pitches on an identical circle having the optical axis L as its center. That is, the light detecting unit 120 in this preferred embodiment includes nine sensors 121.

FIG. 1 illustrates the light detecting unit 120 configured such that the optical-axis sensor 121L is disposed in a location for detecting the optical-axis light-ray bundle RL, and that four sensors 121 are disposed in locations for detecting light that corresponds to adjustment image heights. The light detecting unit 120 further includes other four sensors 121 in an axial direction not shown.

It is noted that when the imaging lens 110 undergoes adjustment on the basis of a single adjustment image height, the optical-axis sensor 121L for instance is disposed, and the first sensors 121a and the third sensors for instance are alternately disposed at 90-degree pitches on an identical circle having the optical axis L as its center. In this case, five sensors 121 in total are disposed.

Further, the sensors 121 do not necessarily have to be disposed at 90-degree pitches around the optical axis L. When three or more sensors 121 are disposed for a single adjustment image height, and when the sensors 121 are disposed around the optical axis L at a known angle, the amount of adjustment in the X-axis direction and Y-axis direction of the adjusted lens 111 can be determined by converting the tilt of an image plane into components in the X-axis direction and Y-axis direction.

When the imaging lens 110 undergoes adjustment on the basis of a single adjustment image height for instance, the light detecting unit 120 may include the optical-axis sensor 121L and the first sensors 121a disposed in the following manner. For instance, the first sensors 121a may be disposed at 120-degree pitches around the optical axis L on concentric circles having the optical axis L as their centers and having the first adjustment image height as their radiuses. The light detecting unit 120 in this case includes four sensors 121 in total.

Further, when the imaging lens 110 undergoes adjustment on the basis of two adjustment image heights, the light detecting unit 120 may include the second sensors 121b disposed in the following manner, in addition to the sensors 121 in the case where the imaging lens 110 undergoes adjustment on the basis of a single adjustment image height. For instance, the second sensors 121b may be disposed at 120-degree pitches around the optical axis L on concentric circles having the optical axis L as their centers and having the second adjustment image height as their radiuses. The light detecting unit 120 in this case includes seven sensors 121 in total.

Furthermore, when the imaging lens 110 undergoes adjustment on the basis of three adjustment image heights, the light detecting unit 120 may include fifth sensors disposed in the following manner and configured to detect fifth light-ray bundles corresponding to a third adjustment image height, in addition to the sensors 121 in the case where the imaging lens 110 undergoes adjustment on the basis of two adjustment image heights. For instance, the fifth sensors may be disposed at 120-degree pitches around the optical axis L on concentric circles having the optical axis L as their centers and having the third adjustment image height as their radiuses. The light detecting unit 120 in this case includes ten sensors 121 in total.

It is noted that the slits 151, disposed in the reticle 150, are disposed in correspondence with the sensors 121.

### Control Unit

The control unit 180 controls the individual units of the imaging-lens manufacturing apparatus 100 and derives a modulation transfer function (MTF) from an image formed by each of the light-ray bundles detected by a corresponding one of the sensors 121.

The control unit 180 controls the defocus mechanism 170 to calculate, while performing defocus, the tilt of an image plane with respect to the optical axis L in accordance with the MTF derived about the pair of first light-ray bundles Ra. The control unit 180 is capable of MTF evaluation in correspondence with defocus by subjecting the imaging lens 110 to defocus and can obtain focal-point information at an adjustment image height of the imaging lens 110. The focal-point information includes information about the focal-point position of each light-ray bundle for instance. The control unit 180 can further determine the tilt of the image plane of the imaging lens 110 on the basis of the focal-point information.

The control unit 180 determines the amount of adjustment of the adjusted lens 111 on the basis of the calculated tilt of the image plane and controls the lens adjusting mechanism 130 to adjust the position of the adjusted lens 111 in the plane perpendicular to the optical axis L.

The control unit 180 controls the lens adjusting mechanism 130 to drive the adjusted lens 111 in the direction of the optical axis L in such a manner that the adjusted lens 111 comes into contact with the lenses (fixed lens 112) excluding the adjusted lens 111.

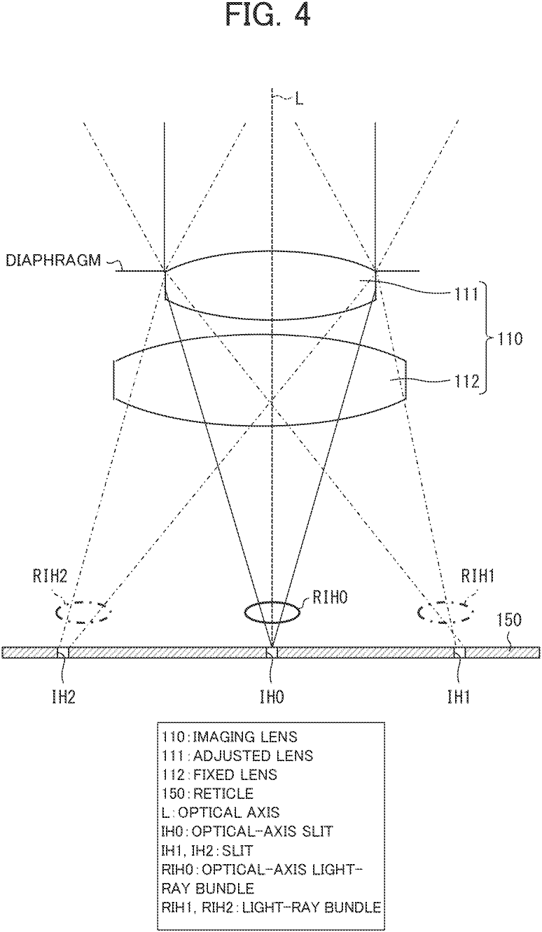

The following describes how the control unit 180 determines the tilt of an image plane with reference to FIG. 4 to FIG. 6. FIG. 4 is a schematic diagram of example pathways in the imaging-lens manufacturing apparatus 100. FIG. 4 illustrates that the image plane of the imaging lens 110 is tilted. To be specific, when focus is achieved at the central image height of the image plane of the imaging lens 110, a light-ray bundle RIH1 passed through a slit IH1, is in focus in front of an ideal image plane, and a light-ray bundle RIH2 passed through a slit IH2 is in focus behind the ideal image plane. The ideal image plane is the plane perpendicular to the optical axis L. Here, the slit IH1 and the slit IH2 are disposed in locations symmetric with respect to the optical axis L, and the focal-point positions of the light-ray bundle RIH1 and light-ray bundle RIH2 are on the ideal image plane and in locations symmetric with respect to the optical axis L on the ideal image plane when the image plane has no tilt.

The imaging lens 110 is typically required to form an image without tilt at all image heights onto the ideal image plane, which is flat typically. That is, it is ideal that the focal-point position of an optical-axis light-ray bundle RIH0 passed through an optical-axis slit IH0, and the focal-point positions of the light-ray bundle RIH1 and light-ray bundle RIH2 are identical. However, variations in manufacturing lenses, or a coaxial misalignment or tilt in assembly cause the image plane to tilt with respect to the ideal image plane, as illustrated in FIG. 4, during a process step for manufacturing the imaging lens 110.

Here, the tilt of the image plane is defined as indicated in Expression (1) below, where PS denotes a peak separation.

$$\text{PS} = \text{FP} 1 - \text{FP} 2 \qquad \text{Expression (1)}$$

Here, FP1 is a focal-point position on the T-plane of the light-ray bundle RIH1 of the imaging lens 110. FP2 is a focal-point position on a T-plane at an image height having the same distance to the optical axis L as FP1 and being in the minus direction. That is, FP2 is a focal-point position on the T-plane of the light-ray bundle RIH2. As described above, the tilt PS can be determined by a difference in focal-point position in the direction of the optical axis L between the positions of a pair of sensors 121.

The following describes how the control unit 180 determines the amount of adjustment. An adjustment amount s of the adjusted lens 111 can be expressed by Expression (2) below when the adjusted lens 111 undergoes positional adjustment in the plane perpendicular to the optical axis L.

$$\text{PS} - \text{k} \times \text{s} = 0 \qquad \text{(2)}$$

Here, PS denotes a difference in focal-point position on a tangential image plane or a sagittal image plane between the positions of a pair of sensors 121, and k denotes a degree of sensitivity at which the difference (PS) in focal-point position varies per unit of the amount of movement of the adjusted lens 111.

In more detail, PS on a tangential image plane is a difference in focal-point position in the direction of the optical axis L on the tangential image plane between the positions of a pair of sensors 121. Further, PS on a sagittal image plane is a difference in focal-point position in the direction of the optical axis L on the sagittal image plane between the positions of the pair of sensors 121. This preferred embodiment uses Expression (2) to determine the adjustment amount s on the tangential image plane.

The control unit 180 calculates a horizontal-movement amount s of the adjusted lens 111 (the adjustment amount s of the position of the adjusted lens 111) in the plane perpendicular to the optical axis L on the basis of foregoing Expression (2). The control unit 180 calculates the horizontal-movement amount s of the adjusted lens 111 in each of two mutually perpendicular axial directions (the X-axis direction and the Y-axis direction) in the plane perpendicular to the optical axis L.

The control unit 180 drives the lens adjusting mechanism 130 on the basis of the calculated horizontal-movement amount s to adjust the adjusted lens 111.

Here, adjusting the imaging lens 110 in such a manner that both tilts on the T-plane and S-plane after adjustment stand at zero is the most desirable, but such adjustment is difficult to achieve.

To be specific, let the difference PS between focal-point positions at two peripheral image heights located symmetrically with respect to the optical axis L, with the central image height as an axis be an index that indicates the tilt of the image plane from the ideal image plane; accordingly, the tilt PS can be expressed as indicated in Expression (3) and Expression (4) below in the adjustment of the adjusted lens 111 through horizontal movement in the plane perpendicular to the optical axis L. However, such large PS as to collapse optical design is not expressed as indicated in these expressions.

$$\text{PS} 1 = \text{k} 1 \text{x} + \text{PSi} 1 \qquad \text{Expression (3)}$$

$$\text{PS2} = \text{k2x} + \text{PSi2} \qquad \text{Expression (4)}$$

Here, PS1 denotes a PS amount on the T-plane, PS2 denotes a PS amount on the S-plane, k1 denotes a degree of sensitivity of the PS amount that varies per unit of the amount of horizontal movement on the T-plane, and k2 denotes a degree of sensitivity of the PS amount that varies per unit of the amount of horizontal movement on the S-plane. Further, x denotes the foregoing horizontal-movement amount of the adjusted lens 111, PSi1 denotes the PS amount on the T-plane before alignment, and PSi2 denotes the PS amount on the S-plane before alignment.

Expression (5) below needs to be satisfied in order to render, using Expression (3) and Expression (4), the image plane tilts on the T-plane and S-plane, i.e., PSi1 and PSi2, zero simultaneously through the foregoing horizontal movement of the adjusted lens 111.

$$\text{x} = - \text{PSi} 1 / \text{k} 1 = - \text{PSi} 2 / \text{k} 2 \qquad \text{Expression (5)}$$

However, satisfying PSi1 / k1 = PSi2 / k2 is difficult in reality. This is because that k1 and k2, which are determined by optical design, are not different among the individual imaging lenses 110 of the same standard, whereas PSi1 and PSi1, which have variations in a production process, take various values among the individual imaging lenses 110.

As such, focusing on the T-plane and such adjustment as to approach the ideal image plane for the image plane tilt on the T-plane, as described in this preferred embodiment, can adjust the imaging lens 110 more realistically.

### Adjustment Image Height

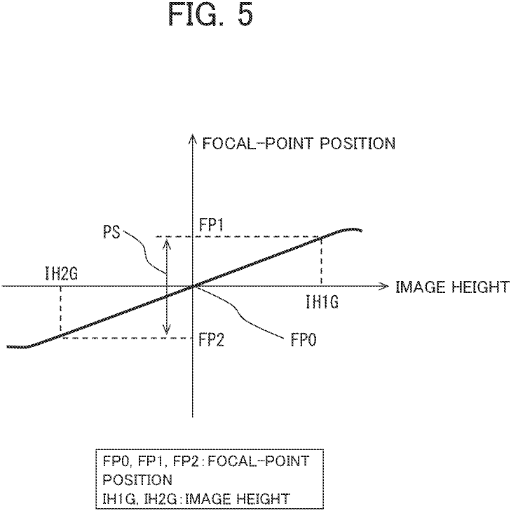

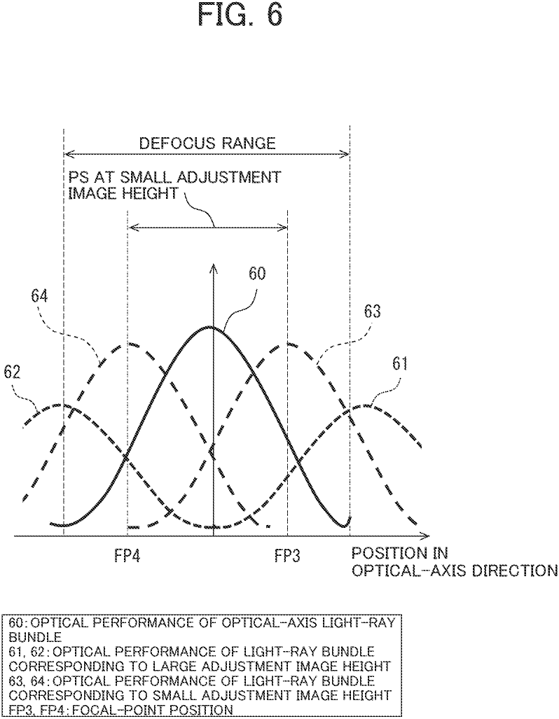

The setting of an adjustment image height will be described with reference to FIG. 5 and FIG. 6. FIG. 5 schematically illustrates the relationship between a tilt PS and a focal-point position. The lateral axis in FIG. 5 indicates the position of an image height on an ideal image plane, and the longitudinal axis in the same indicates a focal-point position in the direction of the optical axis L. FP0, FP1, and FP2 in FIG. 5 are respectively the focal-point position of the optical-axis light-ray bundle RIH0 in FIG. 4, the focal-point position of the light-ray bundle RIH1 in FIG. 4, and the focal-point position of the light-ray bundle RIH2 in FIG. 4. Further, image heights IH1G and IH2G in FIG. 5 are in-focus points on the ideal image planes of the light-ray bundle RIH1 and light-ray bundle RIH2 in the case of no tilt in their image planes and coincide with an adjustment image height.

The tilt PS is the difference between the focal-point position FP1 and the focal-point position FP2, as illustrated in FIG. 5. It is hence obvious that the absolute value of the tilt PS increases along with increase in the adjustment image height even when the image planes are tilted at the same angle. In other words, the sensitivity of the tilt PS with respect to the amount of adjustment of the adjusted lens 111 increases along with increase in the adjustment image height, because an effect resulting from a tilt of an image plane is exerted more easily as an adjustment image height gets higher. A greater adjustment image height offers higher accuracy; this is preferable in calculating the amount of adjustment of the adjusted lens 111.

The absolute value of the adjustment image height for determining the tilt PS is desirably 60% or greater of the radius of the image circle of the imaging lens 110. Further, 100% (maximum image height), which is the end of the image circle of an optical system, or greater increases various tolerances in typical optical design, thereby possibly causing deterioration in adjustment accuracy in obtaining a focal-point position. It is hence preferable that the adjustment image height be 60 to 90% of the radius of the image circle.

However, the adjustment of the adjusted lens 111 based on an adjustment image height of 60% or greater of the radius of the image circle (a first adjustment image height, hereinafter, referred to as a large adjustment image height) increases the sensitivity of the tilt PS, thus causing the following problem. That is, a large amount of adjustment is required for the adjusted lens 111 when, for instance, the placement position of the adjusted lens 111 before adjustment is deviated greatly from the optical axis L of the fixed lens 112. If the focal-point position FP1 and the focal-point position FP2 are off from a defocus range in this case, a MTF cannot be evaluated, thus possibly failing to detect an image plane tilt.

A possible way to address this problem is widening the defocus range; however, this increases the time for production in the imaging-lens manufacturing apparatus 100, thus lowering production efficiency.

Even if the defocus range is widened, a large tilt PS typically tends to lower the values of a MTF at a large adjustment image height, thus lowering the accuracy of detection of the focal-point position FP1 and focal-point position FP2 considerably.

Accordingly, it is effective to adjust the adjusted lens 111 at 10 to 50% of the radius of the image circle (a second adjustment image height, hereinafter, referred to as a small adjustment image height) when the tilt of the image plane cannot be detected at a large adjustment image height.

FIG. 6 is a schematic diagram showing, in each light-ray bundle, the relationship between a position in the direction of the optical axis L and optical performance. The lateral axis in FIG. 6 indicates the position in the direction of the optical axis L, and the longitudinal axis in the same indicates the optical performance. The following describes FIG. 6 using, by way of example, the imaging-lens manufacturing apparatus 100 illustrated in FIG. 1.

A graph 60 in FIG. 6 indicates the optical performance in a location in the direction of the optical axis L of the optical-axis light-ray bundle RL illustrated in FIG. 1. Here, a MTF is applicable to the optical performance. Graphs 61 and 62 in FIG. 6 indicate the optical performance in a location in the direction of the optical axis L of the pair of first light-ray bundles Ra illustrated in FIG. 1. Graphs 63 and 64 in FIG. 6 indicate the optical performance in a location in the direction of the optical axis L of the pair of second light-ray bundles Rb illustrated in FIG. 1. That is, the graphs 61 and 62 in FIG. 6 indicate the optical performance of the first light-ray bundles Ra corresponding to the large adjustment image height, and the graphs 62 and 63 in FIG. 6 indicated the optical performance of the second light-ray bundles Rb corresponding to the small adjustment image height.

In the graphs 60 to 64, locations in which the optical performance is maximum in the direction of the optical axis L are the focal-point positions of the respective light-ray bundles, among which the focal-point position FP3 and the focal-point position FP4 indicate the focal-point positions of the pair of respective second light-ray bundles Rb corresponding to the small adjustment image height.

FIG. 6 shows a tilt PS calculated based on the second light-ray bundles Rb, which correspond to the small adjustment image height, and shows a defocus range. As illustrated in FIG. 6, the sensitivity at the small adjustment image height is small relative to the amount of adjustment of the adjusted lens 111, and thus, the focal-point position FP3 and the focal-point position FP4 (the tilt PS resulting from the small adjustment image height) are less likely to deviate from the defocus range. Further, the degradation in the optical performance is relatively small, and thus, the focal-point position FP3 and the focal-point position FP4 are easy to detect.

In this preferred embodiment, the sensors 121 and the slits 151 are disposed not only in locations corresponding to the large adjustment image height, but also in locations corresponding to the small adjustment image height. This enables the tilt PS to be obtained simultaneously for the two adjustment image heights through a one-time defocus action, thus enabling more accurate adjustment.

Further, when, for instance, the tilt value PS at the large adjustment image height exceeds a predetermined threshold or when, for instance, the tilt PS cannot be measured at the large adjustment image height, the foregoing configuration enables the adjusted lens 111 to be adjusted in accordance with the amount of adjustment calculated based on the tilt PS at the small adjustment image height.

Further, separating the adjustment of the adjusted lens 111 into two or more times: rough adjustment and main adjustment, for the respective large adjustment image height and small adjustment image height, can prevent the amount of adjustment in the rough adjustment. This enables the imaging lens 110 to be adjusted accurately while preventing the defocus range even when a large amount of adjustment is required.

### Method for Manufacturing Lens

The following describes how to achieve the manufacture of the imaging lens 110 by the use of the imaging-lens manufacturing apparatus 100 according to this preferred embodiment. It is noted that the imaging-lens manufacturing apparatus 100, provided by way of example, according to this preferred embodiment has two kinds of adjustment image heights: a large adjustment image height and a small adjustment image height, and that the apparatus detects an MTF that is used for adjustment, at four points on individual concentric circles for each adjustment image height. That is, nine sensors 121 are disposed in a manner similar to that in the imaging-lens manufacturing apparatus 100 illustrated in FIG. 1, and the slits 151, disposed in the reticle 150, are disposed in correspondence with these sensors 121.

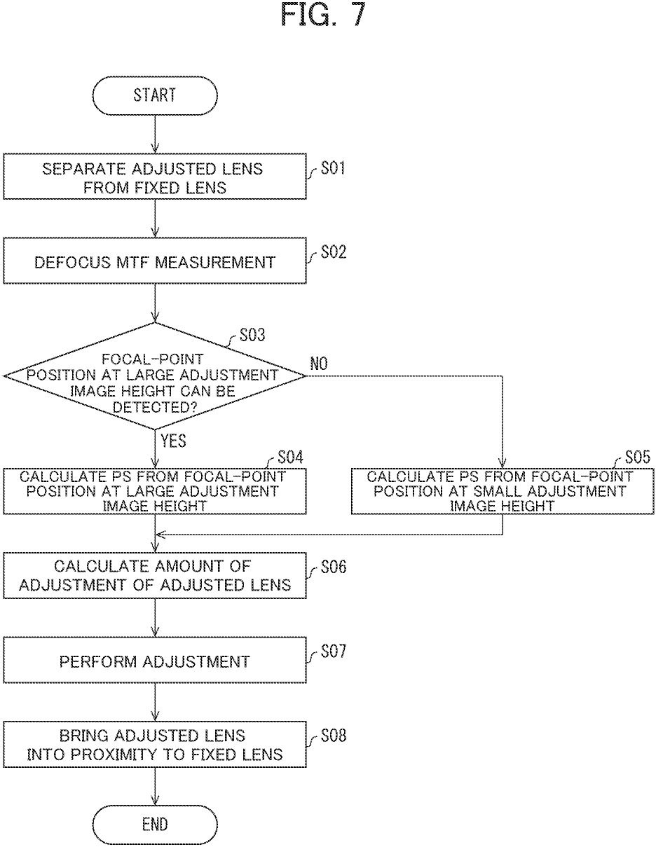

FIG. 7 is a flowchart showing, by way of example, how the imaging-lens manufacturing apparatus 100 according to this preferred embodiment manufactures the imaging lens 110.

The first process step, i.e., Step S01, is separating the adjusted lens 111, included in the imaging lens 110, from the fixed lens 112. In more detail, the lens adjusting mechanism 130 drives the adjusted lens 111 in the direction of the optical axis L to separate the adjusted lens 111 from the fixed lens 112. Separating the adjusted lens 111 from the fixed lens 112 can prevent a frictional resistance between the adjusted lens 111 and the fixed lens 112 during the subsequent adjustment of the imaging lens 110.

The control unit 180 next performs defocus MTF measurement on the imaging lens 110 in Step S02. In more detail, the light detecting unit 120 firstly detects light-ray bundles passed through the slits 151 every time the defocus mechanism 170 defocuses the imaging lens 110 little by little. The control unit 180 next derives the MTFs on the T-plane and S-plane as the optical performance of the imaging lens 110, for an image formed by each light-ray bundle detected by the light detecting unit 120.

The control unit 180 next determines in Step S03 whether a focal-point position at the large adjustment image height can be detected from the MTFs obtained in Step S02. If determining in Step S03 that a focal-point position at the large adjustment image height can be detected (if YES in Step S03), the control unit 180 calculates PS corresponding to the tilt of the image plane from the focal-point position at the large adjustment image height in Step S04.

In contrast, if determining that a focal-point position at the large adjustment image height cannot be detected from the MTFs obtained in Step S02 (if NO in Step S03), the control unit 180 calculates, in Step S05, PS corresponding to the tilt of the image plane from a focal-point position at the small adjustment image height.

The control unit 180 next calculates, in Step S06, the horizontal-movement amount s of the adjusted lens 111 on the basis of Expression (2).

It is noted that the foregoing procedure, i.e., Step S02 through Step S06, is a procedure for calculating the horizontal-movement amount s of the adjusted lens in either one (e.g., the X-axis direction) of two mutually perpendicular axial directions (the X-axis direction and the Y-axis direction) in the plane perpendicular to the optical axis L. However, the pairs of sensor 121 and slit 151 are disposed in each of the X-axis direction and Y-axis direction. The horizontal-movement amount s of the adjusted lens 111 in the other axial direction (e.g., Y-axis direction) is thus also calculated simultaneously.

The control unit 180 next drives, in Step S07, the lens adjusting mechanism 130 on the basis of the derived horizontal-movement amount s to adjust the adjusted lens 111.

Thereafter, Step S08 is bringing the adjusted lens 111 into proximity to the fixed lens 112 and fixing them with an adhesive. At this time, the adjusted lens 111 and the fixed lens 112 need to be brought into proximity by a separation distance established in the Step S01, but their distance can be adjusted to a location for further improving the MTF of the imaging lens 110.

When the distance between the adjusted lens 111 and the fixed lens 112 is not optimal for instance, the image plane is curved by the difference in absolute value between the focal-point position of the optical-axis light-ray bundle RL and the focal-point positions of the first light-ray bundles Ra and second light-ray bundles Rb. When there is a curve in the image plane, regulating, in Step S08, the distance between the adjusted lens 111 and the fixed lens 112 while reflecting this image plane curve can correct the image plane curve.

Such an image plane curve can be derived by the control unit 180 during defocus MTF measurement for the imaging lens 110 in Step S02. The image plane curve changes depending on the distance between the adjusted lens 111 and the fixed lens 112; the tendency of this change, which varies depending on the optical design of the individual imaging lenses 110, is difficult to express simply as a function. However, conducting an optical simulation or an examination in advance to calculate the distance between the adjusted lens 111 and the fixed lens 112 as well as the tendency of change in the image plane curve can offer a lens-to-lens distance at which the MTF of the imagining lens 110 exhibits the best performance.

As described above, the imaging-lens manufacturing apparatus 100 according to this preferred embodiment can achieve a method for manufacturing a high-accuracy imaging lens 110.

### Effects

A method of adjusting a tilt in the imaging lens 110 or in an image sensor in conformance with a tilt in the optical axis L of the imaging lens 110 is typically called active alignment (hereinafter, AA), which is known as a method for manufacturing a camera module. However, performing AA requires a dedicated apparatus, which is unfortunately expensive, and unfortunately complicates the manufacturing process.

Further, AA, which can utilize the performance of the imaging lens 110 at maximum, is an effective method for manufacturing a camera module, but cannot absorb the tilt in the optical axis of the imaging lens 110 without limitation. Using the imaging lens 110 having a greatly tilted optical axis possibly leads to a reduction in the ratio of non-defective products in the process of manufacturing a camera module.

Hence, a tilt in the optical axis should be avoided as much as possible in a means for adjusting the imaging lens 110, and thus, the foregoing adjusting means in Japanese Unexamined Patent Application Publication No. 2010-230745 is unfavorable in view of the manufacture of a camera module.

In contrast to this, the imaging-lens manufacturing apparatus 100 according to this preferred embodiment is directed not to tilting the optical axis L in the adjustment of the imaging lens 110, but to moving the adjusted lens 111 in the plane perpendicular to the optical axis L to adjust the imaging lens 110. As a result, a high-accuracy imaging lens 110 can be manufactured, thereby preventing a reduction in the ratio of non-defective products in the process of manufacturing a camera module.

### Implementation by Software

The functions of the imaging-lens manufacturing apparatus 100 (hereinafter, referred to as an apparatus) can be implemented by a program for a computer to function as the apparatus and to function as each control block of the apparatus (in particular, each unit included in the control unit 180).

The apparatus in this case includes a computer having, as hardware for executing the program, at least one controller (e.g., a processor) and at least one storage (e.g., a memory). Executing the program with these controller and memory implements the individual functions described in the foregoing preferred embodiment.

The program may be stored in one or more non-transitory computer-readable storage media. These storage media may or may not be included in the foregoing apparatus. In the latter case, the program may be supplied to the apparatus via any wired or wireless transmission medium.

Further, the functions of the foregoing individual control blocks can be achieved in part or in whole by logic circuits. For instance, an integrated circuit in which logic circuits that function as the respective control blocks are formed is also included in the scope of the disclosure. Other than the foregoing, the functions of the individual control blocks can be implemented by, for instance, a quantum computer.

Further, each processing descried in the foregoing preferred embodiment may be executed by artificial intelligence (AI). AI in this case may be operated by the foregoing controller or other devices (e.g., an edge computer or a Cloud server).

### Summary

An imaging-lens manufacturing apparatus (100) according to a first aspect of the disclosure manufactures an imaging lens (110) provided with a plurality of lenses including an adjusted lens (111) that is used in assembly. The imaging-lens manufacturing apparatus (100) includes the following: a lens stage (140) configured to hold at least the plurality of lenses (fixed lens 112) excluding the adjusted lens; a lens adjusting mechanism (130) configured to hold the adjusted lens, and capable of adjusting, in a plane perpendicular to the optical axis (L) of the imaging lens, the position of the adjusted lens with respect to the plurality of lenses excluding the adjusted lens; a light source (160); a reticle (150) disposed between the imaging lens and the light source, and having three or more slits (151) that allow light from the light source to pass; and a light detecting unit (120) having a plurality of sensors (121) each configured to detect, via the imaging lens, a corresponding one of a plurality of light-ray bundles composed of the light from the light source passed through the three or more slits, wherein the lens adjusting mechanism is further capable of driving the adjusted lens in the direction of the optical axis.

The foregoing configuration enables the position of the adjusted lens to be adjusted in the plane perpendicular to the optical axis while separating the adjusted lens from the other lenses in the adjustment of the adjusted lens. This can adjust the adjusted lens without a tilt adjustment in the optical axis while reducing a frictional resistance that occurs between the adjusted lens and the other lenses, thereby achieving an imaging-lens manufacturing apparatus that can manufacture a high-accuracy imaging lens.

The imaging-lens manufacturing apparatus (100) according to a second aspect of the disclosure may be configured, in the first aspect, such that the three or more slits (151) are disposed in the reticle (150) in such a manner that the plurality of light-ray bundles include a pair of first light-ray bundles (Ra) that is emitted in a direction symmetric with respect to the optical axis (L), and that each of the pair of first light-ray bundles corresponds to an image height of 60% or greater of a maximum image height, and such that first sensors (121a) included in the plurality of sensors (121) and configured to detect the pair of respective first light-ray bundles are disposed symmetrically with respect to the optical axis.

The foregoing configuration enables the adjusted lens to be adjusted at an image height of 60% or greater, at which the effect of a tilt of an image plane is more likely to be reflected than an image height that is close to the optical axis, and the configuration thus enables accurate adjustment.

The imaging-lens manufacturing apparatus (100) according to a third aspect of the disclosure may include, in the second aspect, the following: a defocus mechanism (170) configured to perform defocus in which the distance of the reticle (150) with respect to the plurality of lenses (fixed lens 112) excluding the adjusted lens (111) held by the lens stage (140) undergoes change in the direction of the optical axis (L); and a control unit (180) configured to control individual units of the imaging-lens manufacturing apparatus, and derive a modulation transfer function (MTF) from an image formed by each of the plurality of light-ray bundles detected by a corresponding one of the plurality of sensors (121), wherein the control unit (180) is further configured to control the defocus mechanism to calculate, while performing the defocus, a tilt of an image plane (G) with respect to the optical axis (L) in accordance with the MTF derived about the pair of first light-ray bundles, control the lens adjusting mechanism (130) in accordance with the tilt of the image plane calculated, to adjust the position of the adjusted lens in the plane perpendicular to the optical axis, and then control the lens adjusting mechanism to drive the adjusted lens in the direction of the optical axis in such a manner that the adjusted lens comes into contact with the plurality of lenses excluding the adjusted lens.

The foregoing configuration enables the imaging lens to be adjusted on the basis of the MTF, which indicates the resolution of the lens, a main specification in its optical performance as a product, and the configuration thus enables a high-accuracy imaging lens to be manufactured.

The imaging-lens manufacturing apparatus (100) according to a fourth aspect of the disclosure may be configured, in the third aspect, such that the adjustment amount (s) of the position of the adjusted lens that undergoes positional adjustment in the plane perpendicular to the optical axis is expressed by the following Expression (E1), where PS denotes a difference in focal-point position on a tangential image plane or a sagittal image plane between the positions of a pair of the first sensors, where k denotes a degree of sensitivity at which the difference in focal-point position varies per unit of the amount of movement of the adjusted lens: PS - k × s = 0 ...... (E1).

In the foregoing configuration, using Expression (E1) enables the amount of horizontal adjustment of the adjusted lens, with which a tilt on the tangential image plane or the sagittal image plane is corrected, to be determined through simple calculation.

The imaging-lens manufacturing apparatus (100) according to a fifth aspect of the disclosure may be configured, in the second aspect, such that the three or more slits (151) are disposed in the reticle (150) in such a manner that the plurality of light-ray bundles include a pair of second light-ray bundles (Rb) that is emitted in a direction symmetric with respect to the optical axis (L), and that each of the pair of second light-ray bundles corresponds to an image height of 10% or greater and 50% or smaller of a maximum image height, and such that second sensors (121b) included in the plurality of sensors (121) and configured to detect the pair of respective second light-ray bundles are disposed symmetrically with respect to the optical axis.

The foregoing configuration enables the tilt of the image plane to be calculated based on two or more image heights, thereby achieving more accurate adjustment of the adjusted lens.

The imaging-lens manufacturing apparatus according to a sixth aspect of the disclosure may be configured, in the fifth aspect, such that the three or more slits (151) are disposed in the reticle (150) in such a manner that the plurality of light-ray bundles further include a third light-ray bundle that is emitted, from the pair of first light-ray bundles (Ra), in a direction rotated about the optical axis (L), and a fourth light-ray bundle that is emitted, from the pair of second light-ray bundles (Rb), in the direction rotated about the optical axis, and such that a third sensor included in the plurality of sensors (121) and configured to detect the third light-ray bundle is disposed in a location rotated about the optical axis from the first sensors (121a), and a fourth sensor included in the plurality of sensors and configured to detect the fourth light-ray bundle is disposed in a location rotated about the optical axis from the second sensors (121b).

The foregoing configuration enables the tilt of the image plane to be calculated based on two or more pairs of light-ray bundles for a single image height, thereby achieving more accurate adjustment of the adjusted lens.

The imaging-lens manufacturing apparatus 100 according to each aspect of the disclosure may be implemented by a computer. In this case, a control program for the imaging-lens manufacturing apparatus 100 in which the imaging-lens manufacturing apparatus 100 is implemented by the computer by operating the computer as each unit (software element) included in the imaging-lens manufacturing apparatus 100, and a computer-readable storage medium storing this control program are also included in the scope of the disclosure.

The disclosure is not limited to the foregoing preferred embodiment. Various modifications can be devised within the scope of the claims. A preferred embodiment that is obtained in combination, as appropriate, with the technical means disclosed in the foregoing preferred embodiment is also included in the technical scope of the disclosure. Furthermore, combining the technical means disclosed in the preferred embodiment can form a new technical feature.

What is claimed is:

1. An imaging-lens manufacturing apparatus that manufactures an imaging lens provided with a plurality of lenses including an adjusted lens that is used in assembly, the imaging-lens manufacturing apparatus comprising:
a lens stage configured to hold at least the plurality of lenses excluding the adjusted lens;
a lens adjusting mechanism configured to hold the adjusted lens, and capable of adjusting, in a plane perpendicular to an optical axis of the imaging lens, a position of the adjusted lens with respect to the plurality of lenses excluding the adjusted lens;
a light source;
a reticle disposed between the imaging lens and the light source, and having three or more slits that allow light from the light source to pass; and
a light detecting unit having a plurality of sensors each configured to detect, via the imaging lens, a corresponding one of a plurality of light-ray bundles composed of the light from the light source passed through the three or more slits,
wherein the lens adjusting mechanism is further capable of driving the adjusted lens in a direction of the optical axis.

2. The imaging-lens manufacturing apparatus according to claim 1, wherein
the three or more slits are disposed in the reticle in such a manner that the plurality of light-ray bundles include a pair of first light-ray bundles that is emitted in a direction symmetric with respect to the optical axis, and that each of the pair of first light-ray bundles corresponds to an image height of 60% or greater of a maximum image height, and
first sensors included in the plurality of sensors and configured to detect the pair of respective first light-ray bundles are disposed symmetrically with respect to the optical axis.

3. The imaging-lens manufacturing apparatus according to claim 2, comprising:
a defocus mechanism configured to perform defocus in which a distance of the reticle with respect to the plurality of lenses excluding the adjusted lens held by the lens stage undergoes change in the direction of the optical axis; and
a control unit configured to control individual units of the imaging-lens manufacturing apparatus, and derive a modulation transfer function (MTF) from an image formed by each of the plurality of light-ray bundles detected by a corresponding one of the plurality of sensors,
wherein the control unit is further configured to
control the defocus mechanism to calculate, while performing the defocus, a tilt of an image plane with respect to the optical axis in accordance with the MTF derived about the pair of first light-ray bundles,
control the lens adjusting mechanism in accordance with the tilt of the image plane calculated, to adjust the position of the adjusted lens in the plane perpendicular to the optical axis, and then
control the lens adjusting mechanism to drive the adjusted lens in the direction of the optical axis in such a manner that the adjusted lens comes into contact with the plurality of lenses excluding the adjusted lens.

4. The imaging-lens manufacturing apparatus according to claim 3, wherein
an adjustment amount (s) of the position of the adjusted lens that undergoes positional adjustment in the plane perpendicular to the optical axis is expressed by the following Expression (E1), where PS denotes a difference in focal-point position on a tangential image plane or a sagittal image plane between positions of a pair of the first sensors, where k denotes a degree of sensitivity at which the difference in focal-point position varies per unit of an amount of movement of the adjusted lens:
$$\text{PS} - \text{k} \times \text{s} = 0 \qquad \text{(E1)}$$
.

5. The imaging-lens manufacturing apparatus according to claim 2, wherein
the three or more slits are disposed in the reticle in such a manner that the plurality of light-ray bundles include a pair of second light-ray bundles that is emitted in a direction symmetric with respect to the optical axis, and that each of the pair of second light-ray bundles corresponds to an image height of 10% or greater and 50% or smaller of a maximum image height, and
second sensors included in the plurality of sensors and configured to detect the pair of respective second light-ray bundles are disposed symmetrically with respect to the optical axis.

6. The imaging-lens manufacturing apparatus according to claim 5, wherein
the three or more slits are disposed in the reticle in such a manner that the plurality of light-ray bundles further include a third light-ray bundle that is emitted, from the pair of first light-ray bundles, in a direction rotated about the optical axis, and a fourth light-ray bundle that is emitted, from the pair of second light-ray bundles, in the direction rotated about the optical axis, and
a third sensor included in the plurality of sensors and configured to detect the third light-ray bundle is disposed in a location rotated about the optical axis from the first sensors, and a fourth sensor included in the plurality of sensors and configured to detect the fourth light-ray bundle is disposed in a location rotated about the optical axis from the second sensors.
